(19) United States
(12) Patent Application Publication
(10) Pub. No.: US 2023/0215411 A1
(43) Pub. Date: Jul. 6, 2023

(54) A TYPE OF ACOUSTIC ABSORBER COMPOSED OF A MICRO-PERFORATED PLATE AND A SET OF ACOUSTIC FILTERS

(71) Applicant: DALIAN UNIVERSITY OF TECHNOLOGY, Dalian (CN)

(72) Inventors: Yulin MEI, Dalian (CN); Xiaoming WANG, Dalian (CN); Yuanxiu WANG, Dalian (CN)

(21) Appl. No.: 17/792,026

(22) PCT Filed: Aug. 31, 2021
(86) PCT No.: PCT/CN2021/115552

§ 371 Date: Jul. 11, 2022

(51) Int. Cl. G10K 11/162; G10K 11/20

(52) U.S. Cl. CPC G10K 11/162; G10K 11/20

(57) ABSTRACT

The type of acoustic absorber comprises a micro-perforated plate, a cavity behind the micro-perforated plate, a slender and curved main acoustic propagation passage communicating with the cavity, and a set of acoustic filters arranged along the main acoustic propagation passage. These acoustic filters have different cut-off frequencies and are arranged in the order of the cutoff frequencies from high to low from the open end to the closed end of the main acoustic propagation passage. The acoustic filter comprises a section of the main acoustic propagation passage and at least one cavity communicating with the main acoustic propagation passage. The type of acoustic absorber is characterized by adopting a main acoustic propagation passage to provide different phase delay for a micro-perforated plate to realize that a micro-perforated plate effectively absorbs broadband acoustic waves, and by combing the close arrangement of main acoustic propagation passage to achieve the ultra-thin structure.

### TECHNICAL FIELD

The present invention belongs to the technical field of acoustic attenuation and absorption, and relates to a type of acoustic absorber composed of a micro-perforated plate and a set of acoustic filters.

### BACKGROUND

Low-frequency acoustic wave attenuation and absorption has been a challenge due to the size limitation of acoustic structures. The present invention discloses a type of acoustic absorber composed of a micro-perforated plate and a set of acoustic filters with different cut-off frequencies, which can effectively attenuate acoustic waves in a wide frequency range and has advantages of small sizes, a simple structure and a low cost.

### SUMMARY

The present invention adopts the following technical solutions:

The type of acoustic absorber comprises a micro-perforated plate, a cavity behind the micro-perforated plate, a main acoustic propagation passage communicating with the cavity behind the micro-perforated plate, and a set of acoustic filters arranged along the main acoustic propagation passage;

The micro-perforated plate has a plate thickness less than or equal to 2 mm and a perforation rate less than or equal to 5%, and diameters of the perforations on the micro-perforated plate are not bigger than 0.5 mm; one side of the micro-perforated plate is the incident surface of external acoustic waves, and the other side is a cavity formed by the side wall; after external acoustic waves pass through the micro-perforated plate, they will enter the cavity behind the micro-perforated plate and travel in the cavity;

The cavity behind the micro-perforated plate is arranged between the micro-perforated plate and the main acoustic propagation passage, and only has two open ends; one end of the cavity is open to the micro-perforated plate and is defined as the inlet; and the other end of the cavity is open to the main acoustic propagation passage, and is defined as the outlet; compared with the inlet of the cavity, the outlet of the cavity is narrower; the volume of the cavity behind the micro-perforated plate is estimated as the product of the area of the micro-perforated plate and the perforation rate of the micro-perforated plate; acoustic waves in the cavity will propagate along the direction from the inlet to the outlet, and finally enter the main acoustic propagation passage;

The main acoustic propagation passage is a slender and curved passage communicating with the cavity behind the micro-perforated plate; one end of the main acoustic propagation passage is open to the cavity behind the micro-perforated plate, and the other end is closed; acoustic waves in the main acoustic propagation passage can propagate from the open end to the closed end; the main acoustic propagation passage has the variable cross-section; the main acoustic propagation passage is closely arranged through the measures of circuity, bending, coiling or stacking in a monolayer or multilayer structural form; according to design requirements, acoustic absorbing materials can be arranged inside the main acoustic propagation passage;

A set of acoustic filters are arranged along the main acoustic propagation passage from the open end to the closed end of the main acoustic propagation passage; these acoustic filters have different cut-off frequencies and are arranged in the order of cut-off frequency from high to low; if the ith acoustic filter in these acoustic filters is Ni and its cut-off frequency is fi, where i=1, 2 . . . n, these acoustic filters arranged from the open end to the closed end of the main acoustic propagation passage are N1, N2 . . . Ni . . . Nn and their cut-off frequencies satisfy f1-f2 > . . . >fi > . . . >fn; N1 is the first acoustic filter arranged near the open end of the main acoustic propagation passage and has the highest cut-off frequency f1; Nn is the last one arranged near the closed end of the main acoustic propagation passage and has the lowest cut-off frequency fn;

After passing through the micro-perforated plate and the cavity behind the micro-perforated plate, acoustic waves enter the main acoustic propagation passage and are guided to propagate from the open end to the closed end of the main acoustic propagation passage; at each acoustic filter arranged along the main acoustic propagation passage, acoustic waves are divided into two parts, where one part goes into the acoustic filter and is absorbed or reflected, and the other part continues propagating along the main acoustic propagation passage;

Each acoustic filter is constructed by a section of the main acoustic propagation passage and at least one cavity, where the section of the main acoustic propagation passage communicates with the cavity; while an acoustic filter only comprises a cavity, the cavity communicates with the section of the main acoustic propagation passage directly or indirectly, such as communicating through a thin branch pipe; while an acoustic filter comprises multiple cavities, the cavity adjacent to the section of the main acoustic propagation passage is defined as the interface cavity, which communicates with the section of the main acoustic propagation passage directly or indirectly, such as communicating through a thin branch pipe; while an acoustic filter comprises multiple cavities, all the cavities are connected directly or indirectly to ensure acoustic waves can enter all the cavities and propagate in these cavities; according to design requirements, one or multiple thin branch pipes can be arranged between a cavity of the acoustic filter and the main acoustic propagation passage; during acoustic waves propagate in an acoustic filter, one part of the acoustic energy is absorbed and the other part is reflected;

Each cavity of the acoustic filter is formed by multiple free surfaces, or by multiple planes, or by multiple surfaces and planes; according to design requirements, acoustic absorbing materials can be arranged inside the cavity;

The volume of each acoustic filter is the sum of equivalent volumes of all cavities of the acoustic filter; if using Vi (i=1, 2 . . . n) to stand for the volume of the ith acoustic filter Ni (i=1, 2 . . . n), these acoustic filters N1, N2 . . . Ni . . . Nn, arranged in the order of cut-off frequency from high to low from the open end to the closed end of the main acoustic propagation passage, satisfy V1<V2< . . . Vi< . . . <Vn; N1 is the first acoustic filter arranged near the open end of the main acoustic propagation passage, having the highest cut-of frequency f1 and the lowest volume V1; Nn is the last one arranged near the closed end of the main acoustic propagation passage, having the lowest cut-off frequency fn and the biggest volume Vn;

The thin branch pipe connecting a cavity of an acoustic filter and the main acoustic propagation passage can extend inside the cavity or doesn't extend; the thin branch pipe connecting a cavity of an acoustic filter and the main acoustic propagation passage can extend inside the main acoustic propagation passage or doesn't extend; the thin branch pipe connecting different cavities of an acoustic filter can extend inside the cavity or doesn't extend; while the cavity of the acoustic filter communicates with the main acoustic propagation passage directly, the main acoustic propagation passage can extend inside the cavity or doesn't extend;

The type of acoustic absorber is characterized by adopting a main acoustic propagation passage to provide different phase delay for a micro-perforated plate to realize that a micro-perforated plate effectively absorbs broadband acoustic waves, and by combing the close arrangement of main acoustic propagation passage to achieve an ultra-thin structure.

### DESCRIPTION OF DRAWINGS

FIG. 1 is a schematic diagram of an acoustic absorber composed of a micro-perforated plate and six acoustic filters.

FIG. 2 is a schematic diagram of an acoustic absorber composed of a micro-perforated plate and six acoustic filters.

FIG. 3 is a schematic diagram of an acoustic absorber composed of a micro-perforated plate and five acoustic filters.

FIG. 4 is a L-shaped main acoustic propagation passage.

FIG. 5 is a U-shaped main acoustic propagation passage.

FIG. 6 is a spiral main acoustic propagation passage.

FIG. 7 is a S-shaped main acoustic propagation passage.

FIG. 8 is a multilayer main acoustic propagation passage.

FIG. 9 is an acoustic filter composed of a cavity and a variable cross-section section of the main acoustic propagation passage.

FIG. 10 is an acoustic filter composed of a cavity, a thin branch pipe and a section of the main acoustic propagation passage.

FIG. 11 is an acoustic filter composed of a cavity and a variable cross-section section of the main acoustic propagation passage, where the main acoustic propagation passage extends inside the cavity.

FIG. 12 is an acoustic filter composed of a cavity, a thin branch pipe and a variable cross-section section of the main acoustic propagation passage with, where the thin branch pipe extends inside the main acoustic propagation passage.

FIG. 13 is an acoustic filter composed of a cavity and a section of the main acoustic propagation passage.

FIG. 14 is an acoustic filter composed of a cavity and a section of the main acoustic propagation passage.

FIG. 15 is an acoustic filter composed of two cavities, a thin branch pipe and a variable cross-section section of the main acoustic propagation passage, where the thin branch pipe connects the two cavities.

FIG. 16 is an acoustic filter composed of two cavities, a thin branch pipe and a section of the main acoustic propagation passage, where the thin branch pipe connects the two cavities and extends inside the cavities.

FIG. 17 is an acoustic filter composed of two cavities, multiple thin branch pipes and a variable cross-section section of the main acoustic propagation passage, where the thin branch pipes connect the two cavities and extend inside the cavities.

FIG. 18 is an acoustic filter composed of two cavities, a thin branch pipe and a variable cross-section section of the main acoustic propagation passage.

FIG. 19 is an acoustic filter composed of two cavities, a thin branch pipe and a section of the main acoustic propagation passage.

FIG. 20 is an acoustic filter composed of two cavities, two thin branch pipes and a section of the main acoustic propagation passage, where the two thin branch pipes connect the two cavities.

FIG. 21 is an acoustic filter composed of two cavities, two thin branch pipes and a variable cross-section section of the main acoustic propagation passage, where one thin branch pipe connects the two cavities and the other connects a cavity to the main acoustic propagation passage and extends inside the cavity and the main acoustic propagation passage.

FIG. 22 is an acoustic filter composed of two cavities, a thin branch pipe and a variable cross-section section of the main acoustic propagation passage.

FIG. 23 is an acoustic filter composed of two cavities, a thin branch pipe and a variable cross-section section of the main acoustic propagation passage, where the thin branch pipe extends inside the cavities.

FIG. 24 is an acoustic filter composed of three cavities, two thin branch pipes and a variable cross-section section of the main acoustic propagation passage, where one thin branch pipe extends inside the cavities and the other doesn't, and the main acoustic propagation passage extends inside the cavity.

FIG. 25 is an acoustic filter composed of three cavities, multiple thin branch pipes and a section of the main acoustic propagation passage, where some thin branch pipes extend inside the cavities and the others don't.

FIG. 26 is an acoustic filter composed of three cavities, multiple thin branch pipes and a variable cross-section section of the main acoustic propagation passage.

FIG. 27 is an acoustic filter composed of five cavities, multiple thin branch pipes and a variable cross-section section of the main acoustic propagation passage, where some thin branch pipes extend inside the cavities and the others don't.

In the figures:

1.the micro-perforated plate; 2.the cavity behind the micro-perforated plate; 3.the open end of the main acoustic propagation passage (the outlet of the cavity behind the micro-perforated plate); 4.the main acoustic propagation passage; 5.the closed end of the main acoustic propagation passage; 6.the acoustic filter arranged along the main acoustic propagation passage; 7.the thin branch pipe; 8.the interface cavity of the acoustic filter; 9.the auxiliary cavity of the acoustic filter;

11.the first acoustic filter arranged along the main acoustic propagation passage; 12.the second acoustic filter arranged along the main acoustic propagation passage; 13.the third acoustic filter arranged along the main acoustic propagation passage; 14.the fourth acoustic filter arranged along the main acoustic propagation passage; 15.the fifth acoustic filter arranged along the main acoustic propagation passage; 16.the sixth acoustic filter arranged along the main acoustic propagation passage; 17.the first layer of the main acoustic propagation passage; 18.the second layer of the main acoustic propagation passage; 19.the third layer of the main acoustic propagation passage; 20.the communicating hole between adjacent layers of the multilayer main acoustic propagation passage;

The arrows in the figures indicate the propagation direction of acoustic waves.

### DETAILED DESCRIPTION

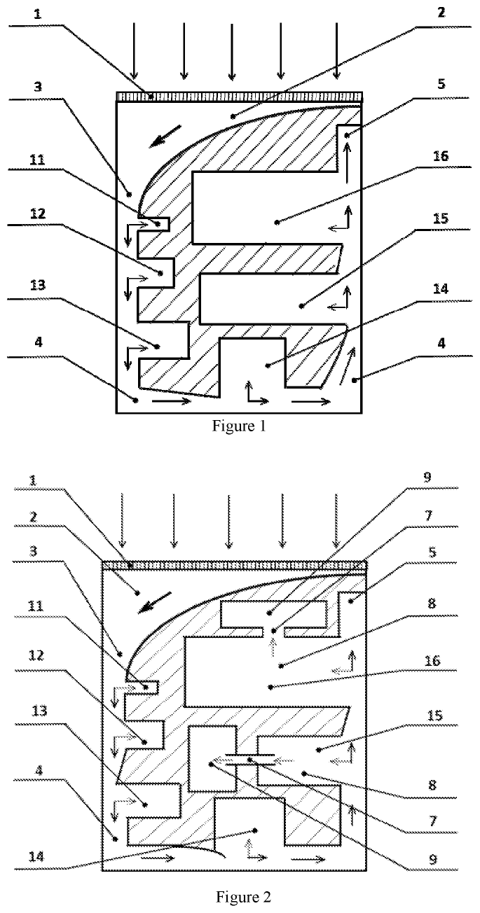

### Embodiment 1: as Shown in FIG. 1

The acoustic absorber comprises a micro-perforated plate 1, a cavity 2 behind the micro-perforated plate 1, a main acoustic propagation passage 4 communicating with the cavity 2, and six acoustic filters arranged along the main acoustic propagation passage 4;

For the micro-perforated plate 1, one side is the incident surface of external acoustic waves, and the other side is the cavity 2 formed by the side wall;

The cavity 2 has two open ends; one end is open to the micro-perforated plate 1 and is defined as the inlet of the cavity; and the other end is open to the main acoustic propagation passage 4, and is defined as the outlet of the cavity; compared with the inlet of the cavity, the outlet of the cavity is narrower; the volume of the cavity 2 is estimated as the product of the area of the micro-perforated plate 1 and the perforation rate of the micro-perforated plate 1; acoustic waves in the cavity 2 propagate along the direction from the inlet to the outlet, and finally enter the main acoustic propagation passage 4;

The main acoustic propagation passage 4 is a single-layer U-shaped passage communicating with the cavity 2; one end 3 of the main acoustic propagation passage 4 is the outlet of the cavity 2, and the other end 5 of the main acoustic propagation passage 4 is closed; the two ends of the main acoustic propagation passage 4 are connected so that acoustic waves in the main acoustic propagation passage 4 can propagate from the open end 3 to the closed end 5; the main acoustic propagation passage 4 has variable cross-section; acoustic absorbing materials are arranged inside the main acoustic propagation passage 4;

Along the main acoustic propagation passage 4, six acoustic filters (11, 12, 13, 14, 15 and 16) are arranged from the open end 3 to the closed end 5; these six acoustic filters have different cut-off frequencies and are arranged in the order of cut-off frequency from high to low; it is assumed that, the cut-off frequencies of acoustic filters 11, 12, 13, 14, 15 and 16 are f1, f2, 13, f4, f5 and f6 and their volumes are V1, V2, V3, V4, V5 and V6, the six acoustic filters 11, 12, 13, 14, 15 and 16 satisfy f1>f2>f3>f4>f5>f6 and V1<V2<V3<V4<V5<V6; the acoustic filter 11 is the first acoustic filter arranged near the open end 3, having the highest cut-off frequency f1 and the lowest volume V1; the acoustic filter 16 is the last acoustic filter arranged near the closed end 5, having the lowest cut-off frequency f6 and the biggest volume V6;

For the six acoustic filters 11, 12, 13, 14, 15 and 16, the acoustic filter 11 is composed of a cavity and a variable cross-section section of the main acoustic propagation passage 4, and the cavity communicates directly with the main acoustic propagation passage 4; the acoustic filter 12 is composed of a cavity and a uniform cross-section section of the main acoustic propagation passage 4, and the cavity communicates directly with the main acoustic propagation passage 4; the acoustic filter 13 is composed of a cavity and a uniform cross-section section of the main acoustic propagation passage 4, and the cavity communicates directly with the main acoustic propagation passage 4; the acoustic filter 14 is composed of a cavity and a variable cross-section section of the main acoustic propagation passage 4, and the cavity communicates directly with the main acoustic propagation passage 4; the acoustic filter 15 is composed of a cavity and a variable cross-section section of the main acoustic propagation passage 4, and the cavity communicates directly with the main acoustic propagation passage 4; the acoustic filter 16 is composed of a cavity and a variable cross-section section of the main acoustic propagation passage 4, and the cavity communicates directly with the main acoustic propagation passage 4;

After passing through the micro-perforated plate 1 and the cavity 2, acoustic waves enter the main acoustic propagation passage 4 and are guided to propagate from the open end 3 to the closed end 5; at each acoustic filter (11, 12, 13, 14, 15 or 16), acoustic waves are divided into two parts, where one part goes into the acoustic filter and is absorbed or reflected, and the other part continues propagating along the main acoustic propagation passage 4.

### Embodiment 2: as Shown in FIG. 2

The embodiment and embodiment 1 are identical but only differ in that:
\hat{1} the acoustic filter 13 is composed of a cavity and a variable cross-section section of the main acoustic propagation passage 4;
\hat{2} the acoustic filter 14 is composed of a cavity and a variable cross-section section of the main acoustic propagation passage 4, and the section of the main acoustic propagation passage 4 extends inside the cavity;
\hat{3} the acoustic filter 15 is composed of an interface cavity 8, an auxiliary cavity 9, a thin branch pipe 7 connecting the cavities 8 and 9, and a section of the main acoustic propagation passage 4, and the thin branch pipe 7 extends inside the cavities 8 and 9;
\hat{4} the acoustic filter 16 is composed of an interface cavity 8, an auxiliary cavity 9, a thin branch pipe 7 connecting the cavities 8 and 9, and a variable cross-section section of the main acoustic propagation passage 4, and the thin branch pipe 7 doesn't extend inside the cavities 8 and 9;
\hat{5} acoustic absorbing materials are arranged inside the cavities 8 and 9.

### Embodiment 3: as Shown in FIG. 3

The acoustic absorber comprises a micro-perforated plate 1, a cavity 2 behind the micro-perforated plate 1, a main acoustic propagation passage 4 communicating with the cavity 2, and five acoustic filters arranged along the main acoustic propagation passage 4;

For the micro-perforated plate 1, one side is the incident surface of external acoustic waves, and the other side is the cavity 2 formed by the side wall;

The cavity 2. has two open ends; one end is open to the micro-perforated plate 1 and is defined as the inlet of the cavity; and the other end is open to the main acoustic propagation passage 4, and is defined as the outlet of the cavity; compared with the inlet of the cavity, the outlet of the cavity is narrower; the volume of the cavity 2 is estimated as the product of the area of the micro-perforated plate 1 and the perforation rate of the micro-perforated plate 1; acoustic waves in the cavity 2 propagate along the direction from the inlet to the outlet, and finally enter the main acoustic propagation passage 4;

The main acoustic propagation passage 4 is a single-layer curved passage communicating with the cavity 2; one end 3 of the main acoustic propagation passage 4 is the outlet of the cavity 2, and the other end 5 of the main acoustic propagation passage 4 is closed; the two ends of the main acoustic propagation passage 4 are connected so that acoustic waves in the main acoustic propagation passage 4 can propagate from the open end 3 to the closed end 5; acoustic absorbing materials are arranged near the acoustic filters inside the main acoustic propagation passage 4;

Along the main acoustic propagation passage 4, five acoustic filters (11, 12, 13, 14 and 15) are arranged from the open end 3 to the closed end 5; these five acoustic filters have different cut-off frequencies and are arranged in the order of cut-off frequency from high to low; it is assumed that, the cut-off frequencies of acoustic filters 11, 12, 13, 14 and 15 are f1, f2, f3, f4 and f5 and their volumes are V1, V2, V3, V4 and V5, the five acoustic filters 11, 12, 13, 14 and 15 satisfy f1>f2>f3>f4>f5 and V1<V2<V3<V4<V5; the acoustic filter 11 is the first acoustic filter arranged near the open end 3, having the highest cut-off frequency f1 and the lowest volume V1; the acoustic filter 15 is the last acoustic filter arranged near the closed end 5, having the lowest cut-off frequency f5 and the biggest volume V5;

For the five acoustic filters 11, 12, 13, 14 and 15, the acoustic filter 11 is composed of a cavity and a section of the main acoustic propagation passage 4, and the cavity communicates directly with the main acoustic propagation passage 4; the acoustic filter 12 is composed of a cavity and a section of the main acoustic propagation passage 4, and the cavity communicates directly with the main acoustic propagation passage 4; the acoustic filter 13 is composed of an interface cavity 8, an auxiliary cavity 9, a thin branch pipe 7 connecting the cavities 8 and 9, and a section of the main acoustic propagation passage 4, and the interface cavity 8 communicates directly with the main acoustic propagation passage 4; the acoustic filter 14 is composed of an interface cavity 8, an auxiliary cavity 9, a thin branch pipe 7 connecting the cavities 8 and 9, and a section of the main acoustic propagation passage 4, and the interface cavity 8 communicates directly with the main acoustic propagation passage 4; the acoustic filter 15 is composed of an interface cavity 8, two auxiliary cavities 9, three thin branch pipes 7 connecting the cavities 8 and 9 as well as the main acoustic propagation passage 4, and a section of the main acoustic propagation passage 4, where the interface cavity 8 communicates with the main acoustic propagation passage 4 through a thin branch pipe 7 and the thin branch pipe 7 connecting two auxiliary cavities 9 extends inside the cavities;

After passing through the micro-perforated plate 1 and the cavity 2, acoustic waves enter the main acoustic propagation passage 4 and are guided to propagate from the open end 3 to the closed end 5; at each acoustic filter (11, 12, 13, 14 or 15), acoustic waves are divided into two parts, where one part goes into the acoustic filter and is absorbed or reflected, and the other part continues propagating along the main acoustic propagation passage 4.

### Embodiment 4:

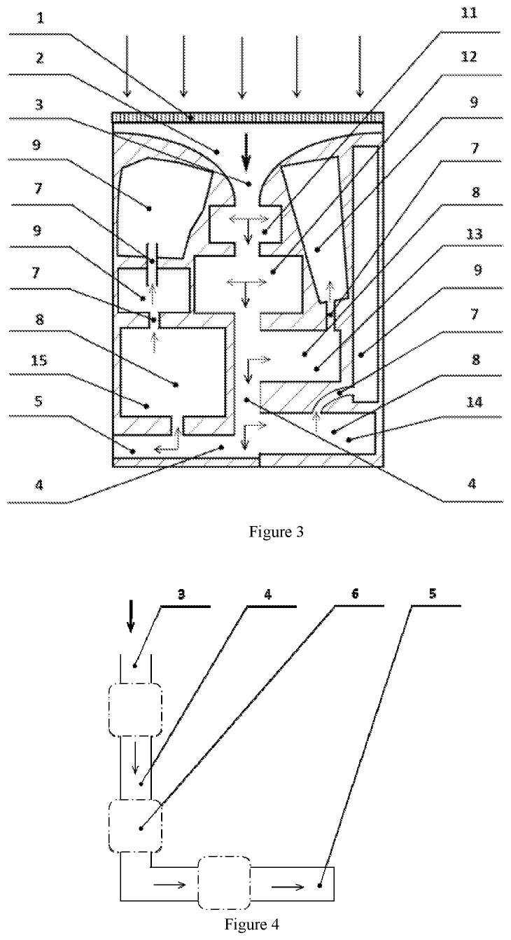

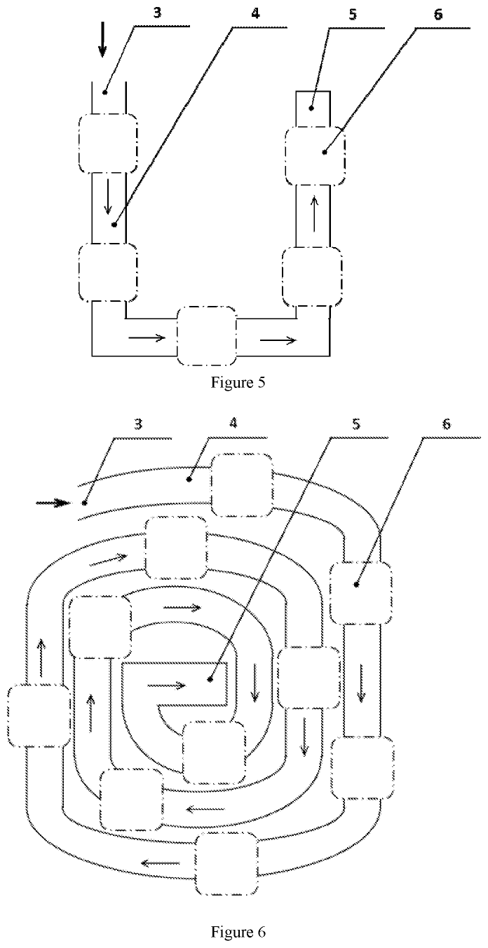

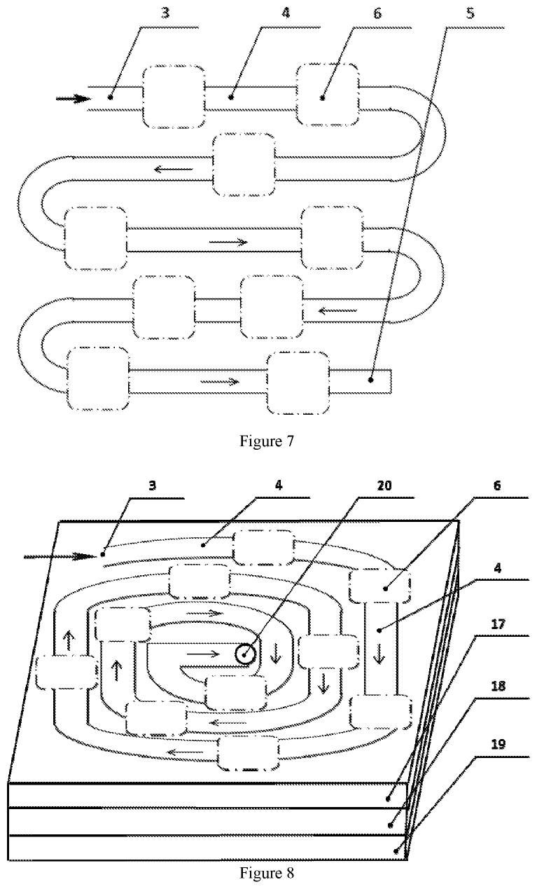

The embodiment and embodiment 1 are identical hut only differ in that:
the main acoustic propagation passage 4 is a single-layer curved passage in FIG. 4 or FIG. 5 or FIG. 6 or FIG. 7.

### Embodiment 5:

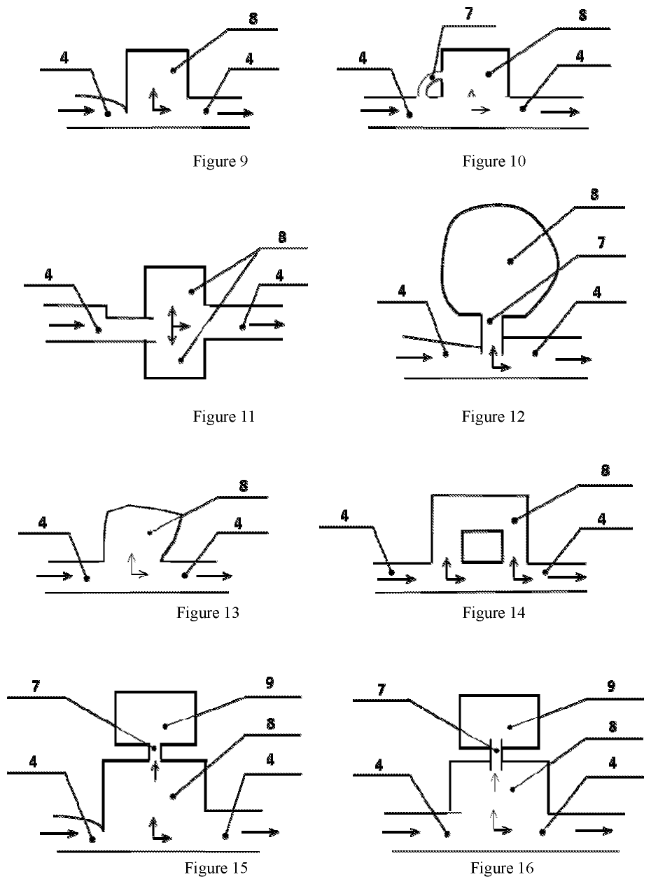

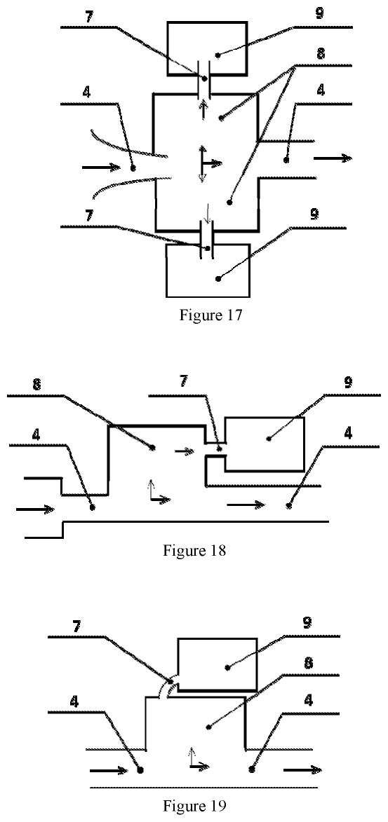

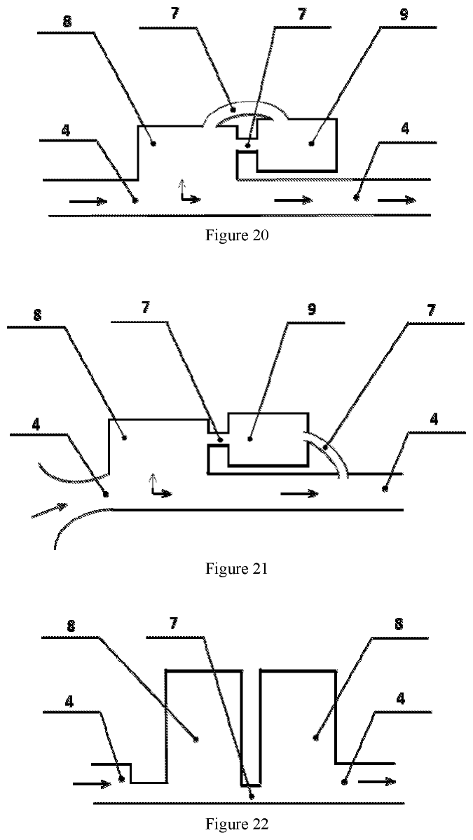

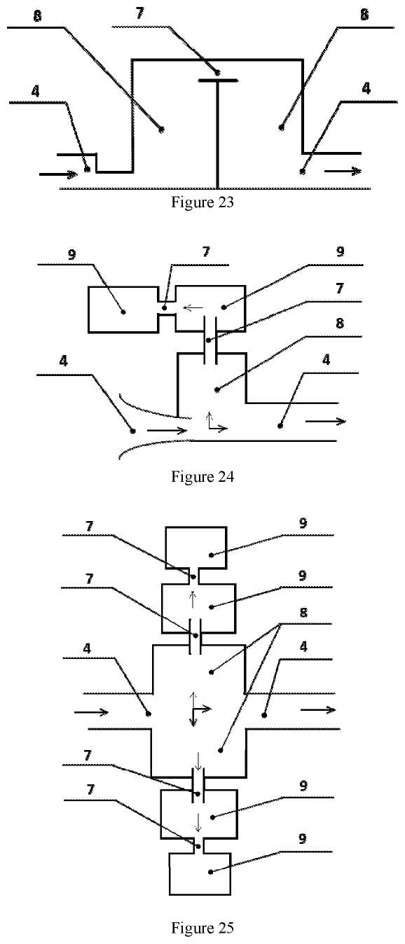

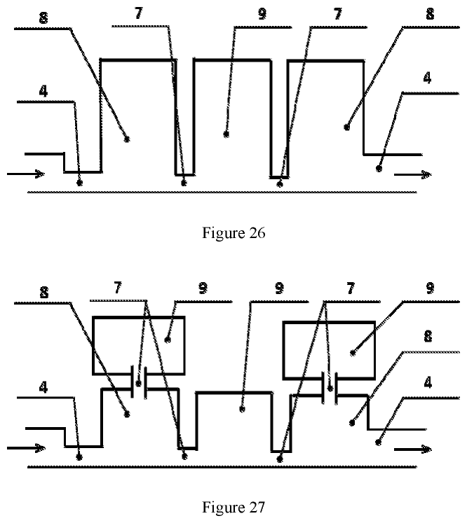

The embodiment and embodiment 3 are identical but only differ in that:
\hat{1} the main acoustic propagation passage 4 is a multi-layer passage in FIG. 8, and at least one communicating hole 20 is manufactured between adjacent layers of the multilayer main acoustic propagation passage to ensure that acoustic waves can propagate from the open end 3 to the closed end 5;
\hat{2} the acoustic filters 11 and 12 are as shown in FIG. 9 or FIG. 10 or FIG. 11 or FIG. 12 or FIG. 13 or FIG. 14;
\hat{3} the acoustic filters 13 and 14 are as shown in FIG. 15 or FIG. 16 or FIG. 17 or FIG. 18 or FIG. 19 or FIG. 20 or FIG. 21 or FIG. 22 or FIG. 23;
\hat{4} the acoustic filter 15 is as shown in FIG. 24 or FIG. 25 or FIG. 26.

### Embodiment 6:

The embodiment and embodiment 3 are identical but only differ in that, the acoustic filter 15 is composed of two interface cavity 8, three auxiliary cavities 9, multiple thin branch pipes 7 connecting the cavities 8 and 9 as well as the main acoustic propagation passage 4, and a section of the main acoustic propagation passage 4, as shown in FIG. 27.

1. A type of acoustic absorber composed of a micro-perforated plate and a set of acoustic filters, characterized by:
comprising a micro-perforated plate, a cavity behind the micro-perforated plate, a main acoustic propagation passage communicating with the cavity behind the micro-perforated plate, and a set of acoustic filters arranged along the main acoustic propagation passage;
wherein the micro-perforated plate has a plate thickness less than or equal to 2 mm and a perforation rate less than or equal to 5%, and diameters of the perforations on the micro-perforated plate are not bigger than 0.5 mm; one side of the micro-perforated plate is the incident surface of external acoustic waves, and the other side is a cavity formed by the side wall; after external acoustic waves pass through the micro-perforated plate, they will enter the cavity behind the micro-perforated plate and travel in the cavity;
wherein the cavity behind the micro-perforated plate connects the micro-perforated plate with the main acoustic propagation passage; the cavity only has two open ends; one end of the cavity is open to the micro-perforated plate and is defined as the inlet; the other end of the cavity is open to the main acoustic propagation passage, and is defined as the outlet; compared with the inlet of the cavity, the outlet of the cavity is narrower; the volume of the cavity is estimated as the product of the area of the micro-perforated plate and the perforation rate of the micro-perforated plate; acoustic waves in the cavity propagate along the direction from the inlet to the outlet, and finally enter the main acoustic propagation passage;
wherein the main acoustic propagation passage is a slender and curved passage communicating with the cavity behind the micro-perforated plate; one end of the main acoustic propagation passage is open to the cavity behind the micro-perforated plate, and the other end is closed; acoustic waves in the main acoustic propagation passage can propagate from the open end to the closed end; the main acoustic propagation passage has the variable cross-section; the main acoustic propagation passage is closely arranged through the measures of circuity, bending, coiling or stacking in a monolayer or multilayer structural form; according to design requirements, acoustic absorbing materials can be arranged inside the main acoustic propagation passage;
wherein a set of acoustic filters are arranged along the main acoustic propagation passage from the open end to the closed end of the main acoustic propagation passage;
these acoustic filters have different cut-off frequencies and are arranged in the order of cut-off frequency from high to low; if the ith acoustic filter in these acoustic filters is Ni and its cut-off frequency is fi, where i=1, 2 . . . n, these acoustic filters arranged from the open end to the closed end of the main acoustic propagation passage are N1, N2 . . . Ni . . . Nn and their cut-off frequencies satisfy f1>f2> . . . >fi> . . . >fn; N1 is the first acoustic filter arranged near the open end of the main acoustic propagation passage and has the highest cut-off frequency f1; Nn is the last one arranged near the closed end of the main acoustic propagation passage and has the lowest cut-off frequency fn;
after passing through the micro-perforated plate and the cavity behind the micro-perforated plate, acoustic waves enter the main acoustic propagation passage and are guided to propagate from the open end to the closed end of the main acoustic propagation passage; at each acoustic filter arranged along the main acoustic propagation passage, acoustic waves are divided into two parts, where one part goes into the acoustic filter and is absorbed or reflected, and the other part continues propagating along the main acoustic propagation passage;
wherein each acoustic filter is constructed by a section of the main acoustic propagation passage and at least one cavity, where the section of the main acoustic propagation passage communicates with the cavity; while an acoustic filter only comprises a cavity, the cavity communicates with the section of the main acoustic propagation passage directly or indirectly, such as communicating through a thin branch pipe; while an acoustic filter comprises multiple cavities, the cavity adjacent to the section of the main acoustic propagation passage is defined as the interface cavity, which communicates with the section of the main acoustic propagation passage directly or indirectly, such as communicating through a thin branch pipe; while an acoustic filter comprises multiple cavities, all cavities are connected directly or indirectly to ensure that acoustic waves can enter all the cavities and propagate in these cavities; according to design requirements, one or multiple thin branch pipes can be arranged between a cavity of the acoustic filter and the main acoustic propagation passage; during acoustic waves propagate in an acoustic filter, one part of the acoustic energy is absorbed and the other part is reflected;
wherein each cavity of an acoustic filter is formed by multiple free surfaces, or by multiple planes, or by multiple surfaces and planes; according to design requirements, acoustic absorbing materials can be arranged inside the cavity;
the volume of each acoustic filter is the sum of equivalent volumes of all cavities of the acoustic filter; if using Vi (i=1, 2 . . . n) to stand for the volume of the ith acoustic filter Ni (i=1, 2 . . . n), these acoustic filters N1, N2 . . . Ni . . . Nn, arranged in the order of cut-off frequency from high to low from the open end to the closed end of the main acoustic propagation passage, satisfy V1<V2< . . . <Vi< . . . <Vn; N1 is the first acoustic filter arranged near the open end of the main acoustic propagation passage, having the highest cut-off frequency f1 and the lowest volume V1; Nn is the last one arranged near the closed end of the main acoustic propagation passage, having the lowest cut-off frequency fn and the biggest volume Vn;
this type of acoustic absorber is characterized by adopting a main acoustic propagation passage to provide different phase delay for a micro-perforated plate to realize that a micro-perforated plate effectively absorbs broadband acoustic waves, and by combing the close arrangement of main acoustic propagation passage to achieve an ultra-thin structure.

2. This type of acoustic absorber composed of a micro-perforated plate and a set of acoustic filters of claim 1, characterized in that: in each acoustic filter arranged along the main acoustic propagation passage, it must be ensured that each cavity of the acoustic filter communicates directly or indirectly with the main acoustic propagation passage to provide at least a propagation path for acoustic waves between each cavity of the acoustic filter and the main acoustic propagation passage.

3. This type of acoustic absorber composed of a micro-perforated plate and a set of acoustic filters of claim 1, characterized in that: the thin branch pipe connecting a cavity of an acoustic filter and the main acoustic propagation passage can extend inside the cavity or doesn't extend; the thin branch pipe connecting a cavity of an acoustic filter and the main acoustic propagation passage can extend inside the main acoustic propagation passage or doesn't extend; the thin branch pipe connecting different cavities of an acoustic filter can extend inside the cavity or doesn't extend; while the cavity of the acoustic filter communicates with the main acoustic propagation passage directly, the main acoustic propagation passage can extend inside the cavity or doesn't extend.
